(19) United States
(12) Patent Application Publication
(10) Pub. No.: US 2012/0102707 A1
(43) Pub. Date: May 3, 2012

(54) METHOD FOR MANUFACTURING SHADE OF A BLIND

(75) Inventor: JU-HUAI CHEN, Ershui Township (TW)

(73) Assignee: Chicology, Inc., Ontario, CA (US)

(21) Appl. No.: 12/917,497

(22) Filed: Nov. 2, 2010

(51) Int. Cl. B23P 11/00

(52) U.S. Cl. 29/428

(57) ABSTRACT

A method for manufacturing a shade of a blind includes the steps of providing a plurality of blades; positioning a pairing unit at at least two ends of each of the blades, wherein at least a side of each of the blades has a pattern portion; and coupling the blades together in an end-to-end manner by the pairing units to form the shade of the blind. Accordingly, not only can the blades be combined or disconnected from each other by pairing units to thereby assemble or disassemble the shade as needed but the blind is also advantageously characterized by ease of assembly, ease of disassembly, and enhanced variability, practicability, and artistic beauty.

### FIELD OF THE INVENTION

The present invention relates to methods for manufacturing a shade of a blind, and more particularly, to a method for manufacturing a shade of a blind characterized by ease of assembly, ease of disassembly, and enhanced variability, practicability, and artistic beauty.

### BACKGROUND OF THE INVENTION

A conventional shade for use with a blind is usually manufactured in the form of a unitary unit and made of an appropriate material, such as cotton, a non-woven fabric, nylon, plastic, or bamboo. To start using the conventional shade for use with a blind, the shade is coupled to a guiding mechanism for moving the shade laterally, thereby allowing the shade to block light, admit light, and look artistically pleasing.

Since the conventional shade for use with a blind is usually manufactured in the form of a unitary unit and made of a specific material, it is unlikely that the conventional shade can be assembled or disassembled as needed according to color, pattern, or size; and, as a result, the conventional shade in use is variable, practical, or artistically appealing.

Accordingly, it is imperative to provide a method for manufacturing a shade configured for use with a blind such that, due to the shade thus manufactured, the blind is advantageously characterized by ease of assembly, ease of disassembly, and enhanced variability, practicability, and artistic beauty.

### SUMMARY OF THE INVENTION

In view of the aforesaid drawbacks of a conventional method for manufacturing a shade of a blind, the inventor of the present invention believes that the conventional method for manufacturing a shade of a blind has room for improvement. Thus, the inventor of the present invention endeavors to improve the conventional method for manufacturing a shade of a blind from the inventor's experience of the related industry. Eventually, the inventor puts forth a method for manufacturing a shade of a blind such that the method is capable of enhancing ease of assembly, ease of disassembly, changeability, industrial applicability, and artistic beauty of the blind using the shade thus manufactured.

It is the primary objective of the present invention to provide a method for manufacturing a shade for use with a blind such that not only can blades of the shade be combined or disconnected from each other by pairing units to thereby assemble or disassemble the shade as needed but the blind is also advantageously characterized by ease of assembly, ease of disassembly, and enhanced variability, practicability, and artistic beauty.

In order to achieve the above and other objectives, the present invention provides a method for manufacturing a shade of a blind. According to an embodiment of the present invention, the method comprises the steps of: providing a plurality of blades and positioning a pairing unit at least two ends of each of the blades. At least a side of each of the blades has a pattern portion. The method further includes the step of coupling the blades together in an end-to-end manner by the pairing units to form the shade of the blind.

In an embodiment of the present invention, the blades are of different colors.

In an embodiment of the present invention, the pattern portions are formed by printing, spray painting, lamination, sewing, or embroidery.

In an embodiment of the present invention, the pattern portions display animal patterns, vegetation patterns, geometrical patterns, text, or numerals.

In an embodiment of the present invention, a receiving region is defined at each of the at least two ends of each of the blades so as for the pairing units to be disposed in the receiving regions, respectively, before the pairing units are fixed to the receiving regions, respectively, by sewing or adhesion.

In an embodiment of the present invention, the pairing units are magnetic bodies attracted to each other.

In an embodiment of the present invention, the pairing units are Velcro straps adhered to each other and disposed at the at least two ends of each of the blades by sewing or adhesion.

In an embodiment of the present invention, the pairing units are fasteners engaged with each other and disposed at the at least two ends of each of the blades by sewing or adhesion.

Accordingly, the present invention provides a method for manufacturing a shade of a blind such that not only can blades of the shade be combined or disconnected from each other by pairing units to thereby assemble or disassemble the shade as needed but the blind is also advantageously characterized by ease of assembly, ease of disassembly, and enhanced variability, practicability, and artistic beauty.

### BRIEF DESCRIPTION OF THE DRAWINGS

A detailed description of the present invention is given below so that a person skilled in the art can fully understand the objectives, features, and advantages of the present invention by referring to the specific embodiments described hereunder in conjunction with the accompanying drawings, in which:

FIG. 1A illustrates an example process flow for making a shade of a blind according to an embodiment of the present invention.

FIG. 1B is a perspective view of the blind according to an embodiment of the present invention;

FIG. 2 is an exploded view of the blind according to an embodiment of the present invention; and

FIG. 3 is a schematic view of the blind as being implemented in an exemplary environment according to an embodiment of the present invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

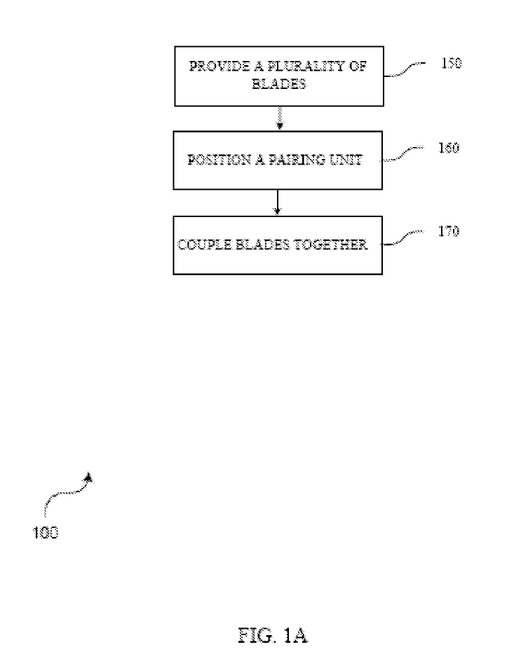

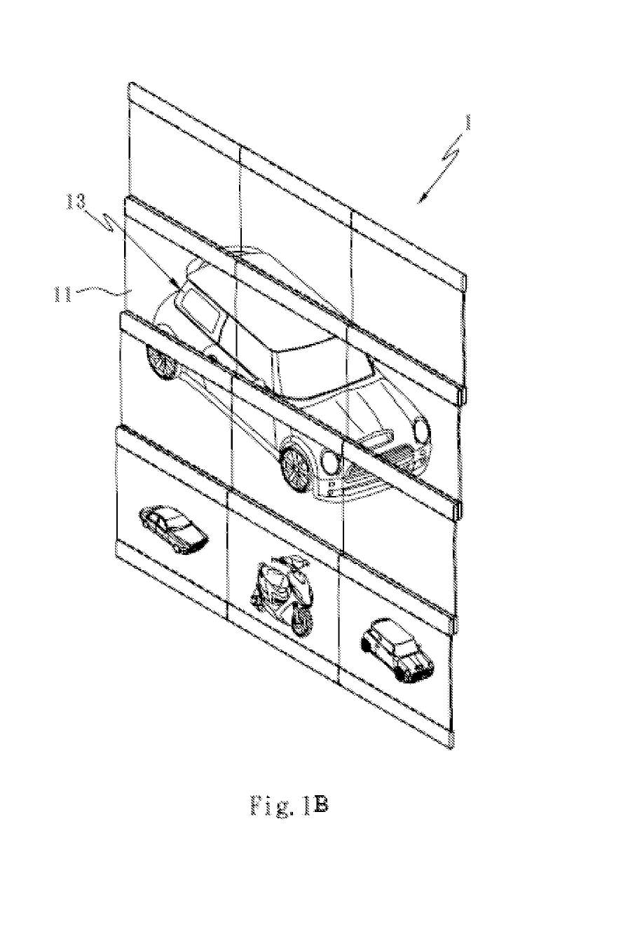

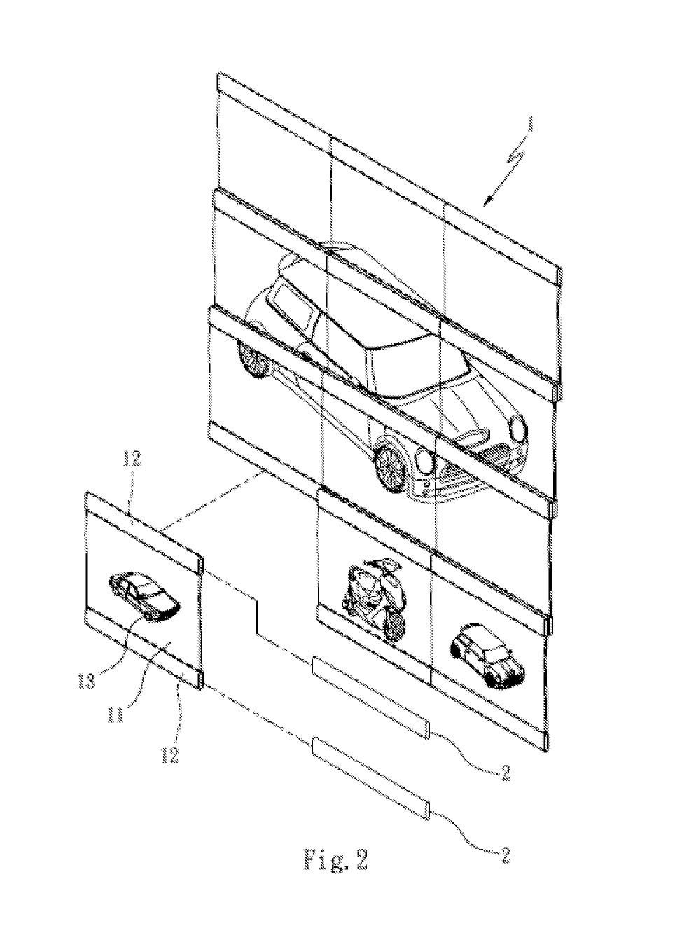

Please refer to FIG. 1B and FIG. 2 for a perspective view and an exploded view of the present invention, respectively. As shown in the drawings, a method for manufacturing a shade 1 of a blind according to the present invention comprises the steps as follows:

FIGS. 1A-B and 2 will now be discussed concurrently. FIG. 1 shows a manufacturing process 100 for making a blind for a shade according to an embodiment of the present invention. Process 100 starts at step 150 where a plurality of blades 11 is provided. Each blade 11 has at least two ends. Each of the ends may include a receiving region 12. In an embodiment, blade 11 may include a pattern or picture on its surface.

At step 160, a pairing unit 2 is positioned into a receiving region 12 of blade 11. Receiving region 12 may be a pocket or compartment that runs along the length of blade 11 where pairing unit 2 may be inserted therein. Alternatively, receiving 12 may be a planar area where pairing unit 2 may be attached thereon using glue, stitches or other fastening means. In one embodiment, pairing unit 2 may be made from a magnetized material having a shape of a bar or pole. Pairing unit 2 may be inserted into receiving region 12 or may be glued or sewn onto receiving region 12. One or more pairing units may be inserted or attached to receiving region 12. The magnet material may have different pole properties such that various pairing units 2 may be magnetically attracted to each other to form paired units.

In one embodiment, pairing unit 2 may have a mechanical fastener surface such as Velcro®. In this way, a pairing unit with one type of mechanical fastening surface (male) may be attached to another pairing unit with another type of mechanical fastening surface (female). Any two mechanical fastener pairing units that can attach to each other may be referred to as paired units. One or more mechanical fastener pairing units may be attached to receiving region 12 by means of glue, stitches, ultrasonic welding, etc. In one embodiment, pairing unit 2 may stretch the entire length of region 12.

In step 170, two blades 11 are coupled to each other. In coupling two of blades 11, the paired units 2 of the two blades 11 may be magnets or mechanical fasteners. Once two of the blades are attached to each other, another blade may be added on to the end of another blade, as shown in FIG. 2.

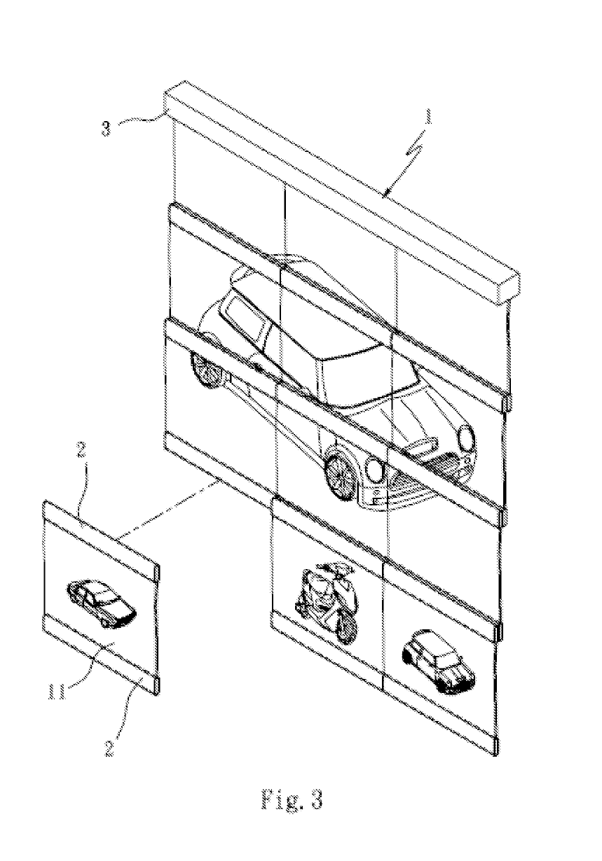

Please refer to FIG. 3 for a schematic view of the working principle of the present invention. As shown in the drawing, to enable the shade of the present invention to function well, it is necessary for the shade of the present invention to further comprise a guiding system 3 (such as a blind rod or a blind frame). To start using the shade of the present invention, a user may put together two of the blades 11. The user may use pairing units 2 made of magnetic materials or mechanical fastening materials. The assembly of the shade 1 of the present invention is effectuated by combining the blades 11 as needed according to the color and pattern of the pattern portions 13, using the magnetic attraction or mechanical coupling between the pairing units 2. After the assembly of the shade 1, the blades 11 can be changed as needed by attaching and detaching the magnetic or mechanical fastener pairs. Hence, the shade 1 can be assembled or disassembled as needed according to color, pattern, or size of the blades 11 to yield the pattern portion 13, for example. In this way, the blind may be easily assembled and disassembled to enhance its variability, practicability, and artistic beauty.

However, according to the present invention, the pairing units 2 are disposed in the receiving regions 12 at the two ends of each of the blades 11 (or at the four margins of each of the blades 11, though the present invention is exemplified by disposing the pairing units 2 at the two ends of each of the blades 11), respectively, to enable a flexible combination of the blades 11. The pairing units 2 are magnetic bodies (such as magnets) attracted to each other. Alternatively, the pairing units 2 are Velcro straps which can be adhered to each other or fasteners which can be engaged with each other. The pairing units 2 are directly disposed at the two ends (not shown) of each of the blades 11 by sewing or adhesion when implemented in the form of Velcro straps or fasteners. The pairing units 2 of the present invention are exemplified by magnetic bodies.

Hence, the present invention meets the three requirements of patentability, namely novelty, non-obviousness, and industrial applicability. Regarding novelty and non-obviousness, the present invention teaches combining the blades or disconnecting the blades from each other by pairing units to thereby assemble or disassemble the shade as needed such that the blind is advantageously characterized by ease of assembly, ease of disassembly, and enhanced variability, practicability, and artistic beauty. Regarding industrial applicability, products derived from the present invention meet market demands fully.

The foregoing preferred embodiments are provided to illustrate and disclose the present invention, and are not intended to be restrictive of the scope of the present invention. Hence, all equivalent modifications and replacement of the foregoing embodiments without departing from the spirit embodied in the disclosure of the present invention should fall within the scope of the present invention as set forth in the appended claims. Accordingly, the scope of the claims of the present invention should be defined by the appended claims.

1. A method for manufacturing a shade of a blind, comprising the steps of:
providing a plurality of blades;
positioning a pairing unit at least two ends of each of the blades, wherein at least a side of each of the blades has a pattern portion; and
coupling the blades together in an end-to-end manner by the pairing units to form the shade of the blind.

2. The method of claim 1, wherein the blades are of different colors.

3. The method of claim 1, wherein the pattern portions are formed by printing, spray painting, lamination, sewing, or embroidery.

4. The method of claim 1, wherein the pattern portions display animal patterns, vegetation patterns, geometrical patterns, text, or numerals.

5. The method of claim 1, wherein a receiving region is defined at each of the at least two ends of each of the blades so as for the pairing units to be disposed in the receiving regions, respectively, before the pairing units are fixed to the receiving regions, respectively, by sewing or adhesion.

6. The method of claim 1, wherein the pairing units are magnetic bodies attracted to each other.

7. The method of claim 1, wherein the pairing units comprises mechanical fasteners that attach to each other and disposed at the at least two ends of each of the blades by sewing or adhesion.

8. The method of claim 1, wherein the pairing units are fasteners engaged with each other and disposed at the at least two ends of each of the blades by sewing or adhesion.
